(19) United States
(12) Patent Application Publication
(10) Pub. No.: US 2008/0292826 A1
(43) Pub. Date: Nov. 27, 2008

(54) CONDUCTIVE SHEET AND MANUFACTURING METHOD THEREOF

(76) Inventors: Koji TANABE, Osaka (JP); Kenichi Matsumoto, Osaka (JP)

Correspondence Address: MCDERMOTT WILL & EMERY LLP, 600 13TH STREET, NW, WASHINGTON, DC, 20005-3096, US

(21) Appl. No.: 12/100,641

(22) Filed: Apr. 10, 2008

(30) Foreign Application Priority Data
May 25, 2007 (JP) 2007-138589

(51) Int. Cl. B05D 5/12; B32B 3/10; B05D 3/02; B32B 5/02

(52) U.S. Cl. 428/48; 427/125

(57) ABSTRACT

A conductive sheet includes a film-like substrate, conductive patterns, and an insulator. The conductive patterns provided on the substrate are made of a synthetic resin dispersed with silver therein. The insulator made of a synthetic resin dispersed with silver chloride therein is provided on the substrate so as to separate the conductive patterns from each other. Followings are the manufacturing method of the conductive sheet. First, a conductive layer including the synthetic resin dispersed with silver therein is formed on the substrate. Next, a solution including a chloride capable of reacting with silver is coated on a predetermined portion of the conductive layer. Finally, the solution coated on the position on the conductive layer is heated to change silver into silver chloride chemically, thereby forming the insulator so as to form the conductive patterns.

### BACKGROUND OF THE INVENTION

1. Field of the Invention

The present invention relates to a conductive sheet for use mainly in a touch panel to operate various electronic devices and a manufacturing method thereof.

2. Background Art

Recently, various electronic devices such as a potable phone and a car navigation system have been enhanced and diversified. Devices that have an optically-transparent and electrostatic touch panel mounted to the front surface of a display element of liquid crystal or the like have been increased. A user switches various functions of the device, by visually recognizing and selecting a character, mark, or pattern displayed on the display element on the back side through the touch panel, and by touching and operating the touch panel with a finger, a dedicated pen or the like. Therefore, touch panels that are excellent in visibility and inexpensive have been demanded.

A conductive sheet used for such a conventional touch panel is described with reference to FIGS. 5, 6A and 6B. The drawing is shown on an expanded scale in a thickness direction to understand the structure easily.

FIG. 5 is a cross-sectional view of a conventional conductive sheet. Conductive sheet 3 includes a film-like light transparent substrate 1 and light transparent belt-shaped conductive patterns 2 formed on substrate 1. Substrate 1 is made of polycarbonate, polyethylene terephthalate or the like and conductive patterns 2 are made of indium tin oxide, tin oxide or the like.

The manufacturing method of conductive sheet 3 is described below with reference to FIGS. 6A and 6B. Predetermined positions on conductive layer 4 formed on the entire top surface of substrate 1 by sputtering or the like are masked by covering with synthetic resin 5 as shown in the cross-sectional view in FIG. 6A. And unnecessary portions in conductive layer 4 are removed by etching in ferric chloride solution or the like to form conductive patterns 2 as shown in FIG. 6B. After peeling off synthetic resin 5, conductive sheet 3 is completed by washing.

Overlapping two sheets of conductive sheets 3 one above the other can form, for instance, an electrostatic type touch panel (not shown). The touch panel is mounted on the front surface of a liquid crystal display element (LCD) of an electronic device. Conductive patterns 2 are connected to electronic circuits of the device for use in selecting various functions of the device. International Publication Pamphlet No. 02/100074 discloses a touch panel using such a conductive sheet, for example.

In the conventional conductive sheet described above, unnecessary positions in conductive layer 4 formed on the entire top surface of substrate 1 are removed by etching after masking to from belt-shaped conductive patters 2. The process takes a long period of time, causing an increase in manufacturing cost.

Additionally, the refractive index of light where conductive layer 4 has been removed differs that of the portion where conductive pattern 2 has been formed. Therefore, a user will inevitably notice the presence of conductive patterns 2 when a touch panel using conductive sheet 3 is mounted on the front surface of an LCD or the like of device. Therefore, it is hard for the user to see the display at the back.

### SUMMARY OF THE INVENTION

The present invention provides a conductive sheet with good visibility, easy to manufacture with low cost. The conductive sheet of the present invention includes a film-like substrate, conductive patterns, and an insulator. Conductive patterns provided on the substrate are made of a synthetic resin dispersed with silver therein. The insulator made of a synthetic resin dispersed with silver chloride therein is provided on the substrate so as to insulate conductive patterns from each other.

Followings are the manufacturing method of the conductive sheet. First, a conductive layer including the synthetic resin dispersed with silver is formed on the substrate. Next, a solution including a chloride capable of reacting with silver is coated on a predetermined position on the conductive layer. Finally, the solution coated on the position on the conductive layer is heated to change silver into silver chloride chemically, thereby forming the insulator so as to form the conductive patterns.

Since it is possible to form the insulator in a simplified way for the conductive patterns, the conductive sheet can be manufactured easily in low cost. Additionally, the conductive patterns and the insulator have the same refractive index, which makes a user hardly distinguish differences between these two visually. Therefore, when a touch panel using the conductive sheet is mounted on the front surface of an LCD or the like, the user can view the display at the back with a high level of visibility.

### BRIEF DESCRIPTION OF THE DRAWINGS

FIG. 1A shows a cross-sectional view of a conductive sheet according to an exemplary embodiment of the present invention.

FIG. 1B shows an enlarged cross-sectional view of the conductive sheet shown in FIG. 1.

FIG. 2 shows a perspective view of the conductive sheet shown in FIG. 1.

FIG. 3A shows a cross-sectional view to explain a manufacturing step of the conductive sheet shown in FIG. 1.

FIG. 3B shows a cross-sectional view to explain another manufacturing step following FIG. 3A.

FIG. 4 shows a cross-sectional view of a touch panel using the conductive sheet shown in FIG. 1.

FIG. 5 shows a cross-sectional view of a conventional conductive sheet.

FIG. 6A shows a cross-sectional view to explain a manufacturing step of the conductive sheet shown in FIG. 5.

FIG. 6B shows a cross-sectional view to explain another manufacturing step following FIG. 6A.

### DETAILED DESCRIPTION OF THE INVENTION

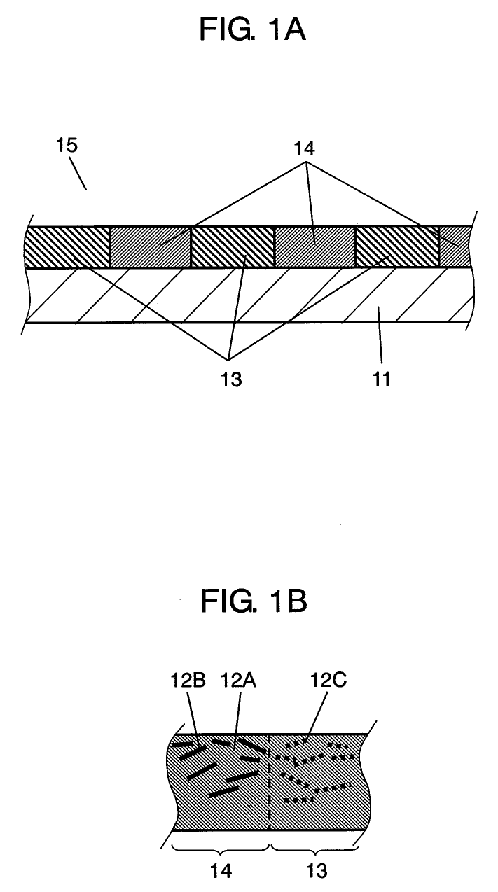

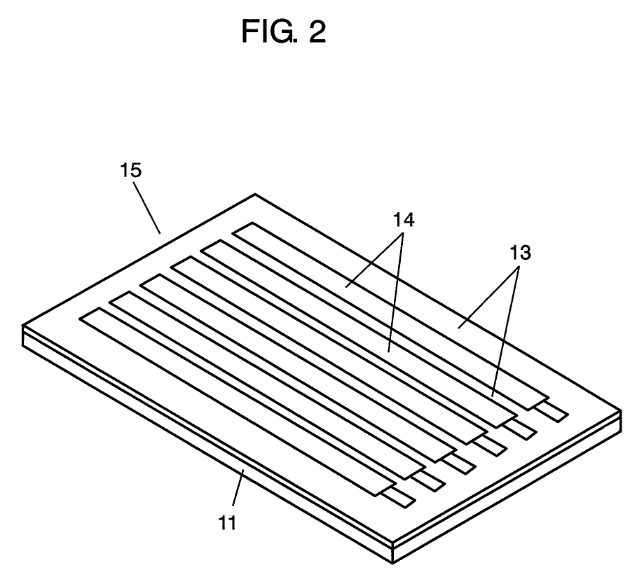

FIG. 1A shows a cross-sectional view of a conductive sheet according to an exemplary embodiment of the present invention. FIG. 1B shows an enlarged cross-sectional view of the same. FIG. 2 shows a perspective view of the same. Views in the drawings are shown in an expanded scale in a thickness direction to understand the configuration easily. Conductive sheet includes film-like substrate 11, conductive patterns 14, and insulators 15. Belt-shaped conductive patterns 14 provided on substrate 11 are made of synthetic resin 12A dispersed with silver 12B. Insulators 13 are provided on substrate 11 so as to insulate conductive patterns 14 from each other. Insulators 13 are made of synthetic resin 12A dispersed with silver chloride 12C.

Light transparent substrate 11 is made of polyethylene terephthalate, polycarbonate, polyimide or the like. It is preferable that silver 12B is needle-like in shape to maintain the light transparency of conductive patterns 14 as well as to provide conductive patterns 14 with electrical conductivity. Synthetic resin 12A is, for instance, acrylic resin or the like.

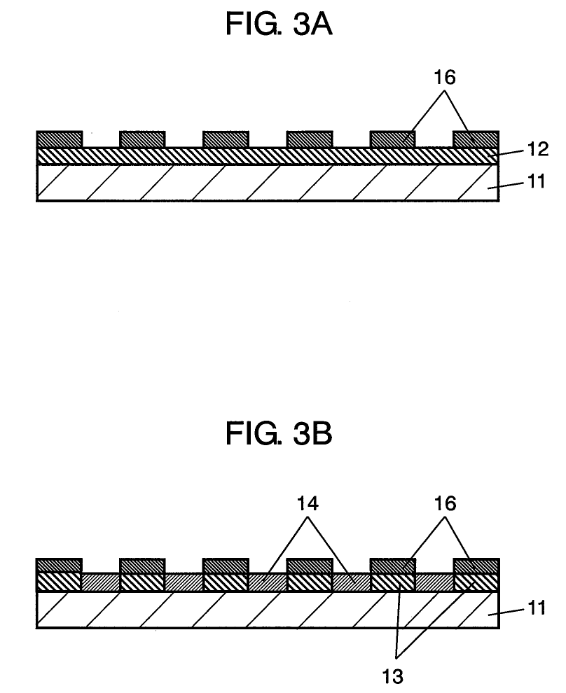

The manufacturing method of conductive sheet 15 is described hereinafter with reference to FIGS. 3A and 3B. Cross-sectional views in FIGS. 3A and 3B illustrate the manufacturing steps of conductive sheet 15.

First, conductive layer 12 is formed on the entire top surface of substrate 11. Conductive layer 12 is formed such that synthetic resin 12A dispersed with silver 12B therein is coated and hardened on the entire top surface of substrate 11. Next, coating layers 16 are formed on the periphery of the top surface and predetermined positions on conductive layer 12 as shown in FIG. 3A. The predetermined positions are the positions to be provided with insulators 13. To provide coating layers 16, for instance, approximately 58 wt % of water is mixed with approximately 8 wt % of polyvinyl-alcohol as a thickener, and is heated at 80° C. to prepare a paste by stirred dissolution. The paste is then added and dispersed with 28 wt % of N-methyl pyrrolidone, 6 wt % of pentyl alcohol and approximately 0.5 wt % of ammonium chloride to prepare a solution. The solution is to form coating layer 16 by screen-printing.

Next, coating layers 16 are heated for 5 minutes at 120° C. for drying. Thereby, silver 12B in each conductive layer 12 under coating layer 16 changes to insulating silver chloride, thus forming insulators 13 as shown in FIG. 3B. In this way, belt-shaped conductive patterns 14 are formed on the top surface of substrate 11, thereby producing conductive sheet 15 with conductive patterns 14 separated from each other electrically by insulators 13.

As the light transparent coating layers 16 are hardly noticeable, they may be left as they are but are preferably removed by washing in hot water. Alternatively, a protective layer composed of a synthetic resin is preferably formed on the top surface of coating layers 16 by screen printing and drying using a water solution dispersed with approximately 12 wt % of polyvinyl alcohol and approximately 2 wt % of pentyl alcohol. These can reduce light reflection or the like and therefore improve light transparency.

Instead of using a synthetic resin such as polyvinyl-alcohol, a paste may be prepared by approximately 60 wt % of water dispersed with approximately 20 wt % of starch as a thickener. A solution is prepared by adding the paste with 20 wt % of N-methyl-pyrrolidone and approximately 0.5 wt % of ammonium chloride. The solution can also form coating layers 16 by screen-printing. Coating layers 16 thus formed can be removed by hot water washing or the like relatively easily after forming insulators 13 and conductive patterns 14 by heating for drying.

Instead of ammonium chloride, ferric chloride or cupric chloride may also form insulator 13 similarly. Each of them may either be used alone or in mixture. Namely, any chloride capable of reacting with silver 12 may be usable.

As described above, the water solution dispersed with a thickener and chlorides is coated on the predetermined positions on conductive layer 12, provided on the top surface of substrate 11, formed from synthetic resin 12A dispersed with silver 12B therein. The solution is then heated for drying to form insulators 13 dispersed with silver chloride 12C. As a result, conductive sheet 15 provided with belt-shaped conductive patterns 14 can be formed by the simple way such as screen-printing. In the process, as the added thickener contributes to form coating layer 16 precisely, conductive patterns 14 can also be formed precisely.

If necessary, foaming agents, leveling agents or the like may be dispersed in the solution used to form coating layers 16. Ink-jet printing or the like may carry out the coating other than screen-printing. Insulator 13 can be formed well if the temperature for drying by heating is not lower than 70° C.

Meanwhile, organic solvent cable of dissolving chlorides may be used for the solution instead of water. For example, solvent typically used for an organic electrolyte is usable as the solvent. Some of the organic solvents have a relatively high viscosity. When using an organic solvent with a high viscosity, it is not necessary to use the thickener if coating layers 16 can be formed precisely.

In conductive sheet 15 thus manufactured, since substrate 11, insulator 13 and conductive pattern 14 are all light transparent and have the same refractive index, they cannot be distinguished from one another visually. Therefore, a touch panel equipped with such conductive sheet 15 has an improved visibility.

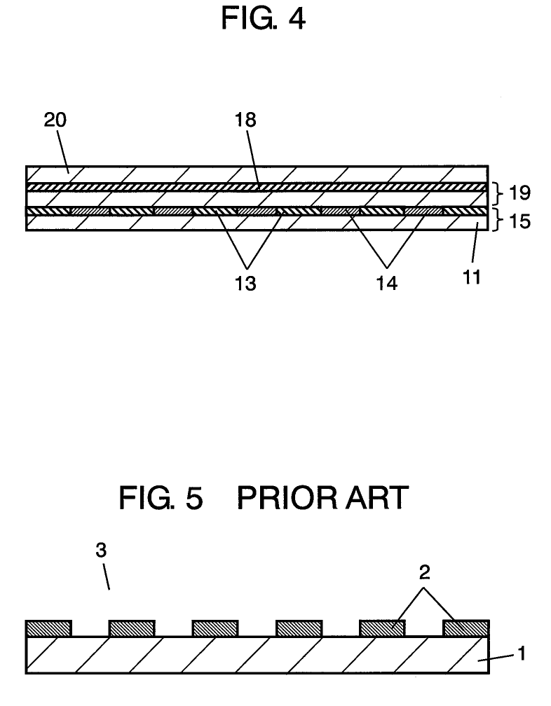

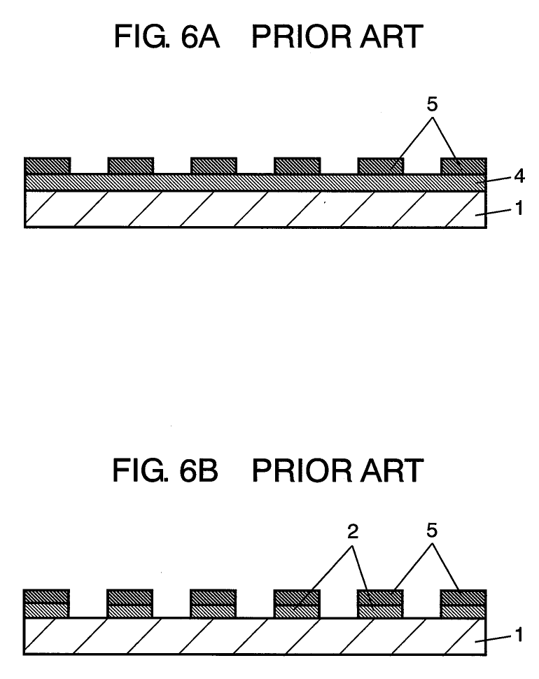

FIG. 4 shows a cross-sectional view of the touch panel using conductive sheet 15. The touch panel includes conductive sheets 15, 19, and protective sheet 20. Conductive sheet 19 has the same structure as conductive sheet 15, having conductive patterns 18 on its top surface. Conductive sheet 19 is laminated on the top surface of conductive sheet 15 such that conductive patterns 18 are arranged in a direction perpendicular to the arranged direction of conductive patterns 14. Film-like light transparent protective layer 20 is stuck on the top surface of conductive sheet 19. An electrostatic type touch panel is formed as above, for example.

Such a touch panel is mounted on the front surface of an LCD (not shown) to be installed on an electronic device and conductive patterns 14 and 18 are connected to an electronic circuit of the device (not shown) to select respective functions of the device.

Namely, upon voltage is applied from the electronic circuit to conductive patterns 14 and 18 sequentially, a user touches a portion by a finger on the top surface of protective sheet 20 to operate the electronic device. The electrostatic capacitance between one of conductive patterns 14 and one of conductive patterns 18 changes accordingly. The electronic circuit detects the operated portion from the change and selects various functions of the device in response to the operated portion.

In this touch panel, conductive patterns 14, 18 and insulators 13 have a similar value of refractive index, so that these are hardly distinguished visually from one another. Therefore, a user can see the display with ease and can operate the touch panel with a good visibility when viewing to choose a letter, a symbol, a picture or the like shown in the LCD or the like at the back through the touch panel.

As described above, according to the embodiment of the present, conductive sheet 15 can be manufactured by an easy manufacturing method with low cost by forming conductive patterns 14 in a simplified way such as printing method or the like. Moreover, conductive patterns 14 and insulators 13 have a similar value of refractive index and are hardly distinguished visually each other. Therefore, when a touch panel with the conductive sheet is mounted on the front surface of an LCD, a user could have a good visibility on the display at the back.

In the above description, conductive pattern 14 is described to have a structure having conductive patterns 14 with predetermined width arranged in a predetermined clearance therebetween, but the form of the conductive patterns is not intended to limit to this only. The present invention can be available in various forms of conductive patterns such as having a shape of; coupled squares, several pieces connected together or folded.

As described above, the manufacturing method of the present invention can realize the conductive sheet with a good visibility, easy to manufacture with low cost. Therefore, the conductive sheet is useful for touch panels or parts for printed circuit board used to operate a variety of electronic device.

What is claimed is:

1. A conductive sheet, comprising:
a film-like substrate;
conductive patterns made of a synthetic resin dispersed with silver therein, the conductive patterns being provided on the substrate; and
an insulator made of a synthetic resin dispersed with silver chloride therein, the insulator being provided on the substrate so as to separate the conductive patterns from each other.

2. The conductive sheet according to claim 1, wherein the silver is needle-like in shape.

3. A manufacturing method of a conductive sheet, comprising:
forming a conductive layer including a synthetic resin dispersed with silver therein on a film-like substrate;
coating a solution including a chloride capable of reacting with the silver;
and
forming conductive patterns by forming an insulator by changing the silver in a position coated with the solution on the conductive layer into silver chloride chemically by heating for drying.

4. The manufacturing method of the conductive sheet according to claim 3, wherein the chloride includes at least one of ammonium chloride, ferric chloride and cupric chloride.

5. The manufacturing method of the conductive sheet according to claim 3, wherein the solution includes a thickener.
